(19) United States
(12) Patent Application Publication
(10) Pub. No.: US 2025/0131331 A1
(43) Pub. Date: Apr. 24, 2025

(54) METHOD FOR TRAINING ARTIFICIAL INTELLIGENCE MODEL FOR EXECUTABLE ON EMBEDDED DEVICE

(71) Applicant: NOTA, INC., Daejeon (KR)

(72) Inventors: Sangtae KIM, Daejeon (KR); Jihoon LEE, Daejeon (KR); Sukin EO, Daejeon (KR); Eunsik JUNG, Daejeon (KR); Wheemyung SHIN, Daejeon (KR)

(21) Appl. No.: 18/916,441

(22) Filed: Oct. 15, 2024

(30) Foreign Application Priority Data
Oct. 18, 2023 (KR) 10-2023-0139600
Jul. 31, 2024 (KR) 10-2024-0101878

(51) Int. Cl. G06N 20/00

(52) U.S. Cl. CPC G06N 20/00

(57) ABSTRACT

Disclosed is a method for training an artificial intelligence (AI) model on a computing device (CD), which is executable on an embedded device (ED). The method includes transforming a first AI model pretrained on a first execution environment (EE) of the CD into a second AI model corresponding to the ED having a second EE which is different from the first EE of the CD. The method includes synchronizing the second AI model and a dataset stored on the CD with a network storage module connected via a network to the CD and the ED, requesting the ED to perform inference of the synchronized second AI model using the synchronized dataset in the second EE, and receiving first result data according to the performance of the inference from the ED. The method includes training the second AI model to be executed on the ED, using the first result data.

### CROSS-REFERENCE TO RELATED APPLICATIONS

This application claims priority to and the benefit of Korean Patent Application No. 10-2023-0139600 filed in the Korean Intellectual Property Office on 18 Oct. 2023, and Korean Patent Application No. 10-2024-0101878 filed in the Korean Intellectual Property Office on 31 Jul. 2024, the entire contents of which are incorporated herein by reference.

### TECHNICAL FIELD

The present disclosure relates to training of an artificial intelligence model, and more particularly, a method for training, by a computing device, an artificial intelligence model executable on an embedded device.

### DESCRIPTION OF THE RELATED BACKGROUND ART

An embedded device as an electronic device designed for a specific purpose may mean a type in which hardware and software are combined to perform a specific function. In recent years, the embedded device is equipped with a neural processing unit (NPU) for data processing using artificial intelligence. The neural processing unit (NPU) may be hardware designed to be suitable for processing associated with the artificial intelligence. Accordingly, the embedded device is equipped with the neural processing unit (NPU) to more rapidly perform processing for specific data.

In general, the embedded device has a small size, and does not require processing of a lot of data, so the embedded device uses a low-specification neural processing unit. The embedded device using the low-specification neural processing unit uses a minimal flash memory to reduce costs. Accordingly, the embedded device may have an insufficient storage space due to the small flash memory. The embedded device may be limited in performing a test by using multiple resources required for developing the artificial intelligence model due to the insufficient storage space, and also limited in performing an evaluation in a development process.

### BRIEF SUMMARY

The present disclosure is contrived in response the above-described background art, and has been made in an effort to provide a method for efficiently training, by a computing device, an artificial intelligence model executable on an embedded device.

The present disclosure has been made in an effort to provide a technique for flexibly and efficiently performing, by the computing device, development of the artificial intelligence model on the embedded device.

Technical objects of the present disclosure are not restricted to the technical object mentioned as above. Other unmentioned technical objects will be apparently appreciated by those skilled in the art by referencing the following description.

An exemplary embodiment of the present disclosure provides a method for training an artificial intelligence model on a computing device, which is executable on an embedded device. The method may be performed by the computing device. The method may include: transforming a first artificial intelligence model pretrained on a first execution environment of the computing device into a second artificial intelligence model corresponding to the embedded device having a second execution environment which is different from the first environment of the computing device, wherein the transforming comprises transforming weights or activation values in a model from a format of a first bit precision supported by the first execution environment to a format of a second bit precision supported by the second execution environment, where a value of the first bit precision is greater than a value of the second bit precision; synchronizing the second artificial intelligence model and a dataset stored on the computing device with a network storage module connected via a network to the computing device and the embedded device, wherein the synchronized dataset and the synchronized second artificial intelligence model are accessible by both the computing device and the embedded device; requesting the embedded device to perform inference of the synchronized second artificial intelligence model using the synchronized dataset in the second execution environment, and receiving first result data according to the performance of the inference from the embedded device; and training, by the computing device, the second artificial intelligence model to be executed on the embedded device, using the first result data, and wherein the requesting the embedded device to perform the inference of the synchronized second artificial intelligence model using the synchronized dataset in the second execution environment comprises: transmitting an initialization request for a driver to perform inference on the embedded device and an inference request signal including path information of the synchronized dataset on the network storage module, to the embedded device.

Alternatively, the training the second artificial intelligence model to be executed on the embedded device, using the first result data may include: updating, by the computing device, loss of the first artificial intelligence model based on the first result data; and updating, by the computing device, weights of the second artificial intelligence model based on the updated loss of the first artificial intelligence model.

Alternatively, the updating the loss of the first artificial intelligence model based on the first result data may include updating the loss of the first artificial intelligence model using difference between the first result data and ground truth data of the dataset, wherein the first result data is transformed by the embedded device to correspond to the computing device having the first execution environment.

Alternatively, the updating the loss of the first artificial intelligence model based on the first result data may include transforming the first result data to correspond to the computing device having the first execution environment, and updating the loss of the first artificial intelligence model using the difference between the transformed first result data and the ground truth data of the dataset.

Alternatively, the updating the weights of the second artificial intelligence model based on the updated loss of the first artificial intelligence model may include: generating a third artificial intelligence model which is quantized to the second bit, by transforming the first artificial intelligence model which includes the updated loss, to correspond to the embedded device; and updating the weights of the second artificial intelligence model with weights of the third artificial intelligence model by synchronizing the third artificial intelligence model with the network storage module.

Alternatively, the updating the loss of the first artificial intelligence model based on the first result data may include: obtaining second result data from input data including the dataset using the first artificial intelligence model; calculating knowledge distillation loss using difference between the first result data of the second artificial intelligence model and the second result data of the first artificial intelligence model; calculating the loss of the first artificial intelligence model using the difference between the second result data of the first artificial intelligence model and ground truth data of the dataset; and updating the loss of the first artificial intelligence model by reflecting the calculated knowledge distillation loss and the calculated loss of the first artificial intelligence model into the first artificial intelligence model, and the updating the weights of the second artificial intelligence model based on the loss of the first artificial intelligence model may include updating the weights of the second artificial intelligence model based on the calculated knowledge distillation loss and the loss of the first artificial intelligence model.

Alternatively, the inference request signal may further include batch-specific path information synchronized on the network storage module when the performance request of the inference is a performance request of batch inference.

Alternatively, the first execution environment may include a computing execution environment operable by at least one of a central processing unit (CPU) or a graphics processing unit (GPU), and the second execution environment may include a computing execution environment operable by a neural processing unit (NPU).

Alternatively, the first artificial intelligence model may be located in a storage space of the computing device, and the dataset for training the second artificial intelligence model and the second artificial intelligence model may be generated or obtained by the computing device.

Alternatively, the method may further include: after the transforming the first artificial intelligence model into the second artificial intelligence model, when it is determined that an abnormality associated with the second artificial intelligence model exists based on tensors of output data output by inputting the same input data into both the first artificial intelligence model and the second artificial intelligence model, identifying a cause of the abnormality associated with the second artificial intelligence model using a way of changing a shape of a matrix of data.

Alternatively, the way of changing the shape of the matrix of data may involve changing the shape of the matrix of the data without performing a separate transformation process to transform the artificial intelligence model, and when the cause of the abnormality associated with the second artificial intelligence model is determined not to have originated from the shape of the matrix of the data, the method may return to the transforming the first artificial intelligence model.

Alternatively, the abnormality associated with the second artificial intelligence model may be identified as abnormality when a similarity between tensors of the output data is less than a predetermined threshold.

Alternatively, the method may further include: after the transforming the first artificial intelligence model into the second artificial intelligence model, synchronizing a dummy dataset for testing stored on the computing device with the network storage module; generating third result data by performing inference of the first artificial intelligence model using the dummy dataset in the first execution environment and synchronizing the generated third result data with the network storage module; and receiving a validation result of the second artificial intelligence model generated at least partially based on the synchronized dummy dataset and the synchronized third result data from the embedded device.

Alternatively, the validation result of the second artificial intelligence model may be generated by the embedded device by determining a first similarity between fourth result data obtained by performing inference of the second artificial intelligence model using the synchronized dummy dataset in the second execution environment and the synchronized third result data.

Alternatively, the validation result of the second artificial intelligence model may be generated, by applying a flatten into the third result data and the fourth result data to transform the third result data and the fourth result data into one dimension, sorting the flattened third result data and the flattened fourth result data using a predetermined criterion, and determining the first similarity between the sorted third result data and the sorted fourth result data.

Alternatively, when the first similarity is less than a predetermined threshold, it may be determined that an abnormality associated with the second artificial intelligence model exists, and the method may further include identifying a cause of the abnormality associated with the second artificial intelligence model using a way of changing a shape of a matrix of data when it is determined that the abnormality exists.

Alternatively, the identifying the cause of the abnormality may further include: after changing the shape of the matrix of data, generating fifth result data by performing inference of the first artificial intelligence model using the dummy dataset in the first execution environment and synchronizing the generated fifth result data with the network storage module; receiving second similarity between sixth result data obtained by performing inference of the second artificial intelligence model with the changed shape of the matrix of data using the synchronized dummy dataset in the second execution environment and the synchronized fifth result data, from the embedded device; and identifying the cause of the abnormality based on the second similarity, and the identifying the cause of the abnormality based on the second similarity may include determining that the abnormality associated with the second artificial intelligence model is originated by the shape of the matrix of the data when the second similarity is greater than or equal to a predetermined threshold.

Alternatively, the transforming the first artificial intelligence model may include quantizing the first artificial intelligence model operable in the first execution environment of the computing device into the second artificial intelligence model operable in the second execution environment of the embedded device using an application programming interface (API) for quantizing to a model operable on the embedded device, wherein the second artificial intelligence model is incapable of being executed or simulated on the computing device, and is capable of being executed or simulated on the embedded device, and a quantization algorithm or quantization parameter in the application programming interface (API) may be a structure which is not recognized by the computing device.

Another exemplary embodiment of the present disclosure provides a computer program stored in a computer-readable storage medium. The computer program may allow a processor of a computing device to perform a method for training an artificial intelligence model executable on an embedded device. The method may include: transforming a first artificial intelligence model pretrained on a first execution environment of the computing device into a second artificial intelligence model corresponding to the embedded device having a second execution environment which is different from the first environment of the computing device, wherein the transforming comprises transforming weights or activation values in a model from a format of a first bit precision supported by the first execution environment to a format of a second bit precision supported by the second execution environment, where a value of the first bit precision is greater than a value of the second bit precision; synchronizing the second artificial intelligence model and a dataset stored on the computing device with a network storage module connected via a network to the computing device and the embedded device, wherein the synchronized dataset and the synchronized second artificial intelligence model are accessible by both the computing device and the embedded device; requesting the embedded device to perform inference of the synchronized second artificial intelligence model using the synchronized dataset in the second execution environment, and receiving first result data according to the performance of the inference from the embedded device; and training, by the computing device, the second artificial intelligence model to be executed on the embedded device, using the first result data, and wherein the requesting the embedded device to perform the inference of the synchronized second artificial intelligence model using the synchronized dataset in the second execution environment comprises: transmitting an initialization request for a driver to perform inference on the embedded device and an inference request signal including path information of the synchronized dataset on the network storage module, to the embedded device.

Yet another exemplary embodiment of the present disclosure provides a computing device for training an artificial intelligence model executable on an embedded device. The computing device may include: a processor; a memory; and a network unit. The processor may perform an operation of transforming a first artificial intelligence model pretrained on a first execution environment of the computing device into a second artificial intelligence model corresponding to the embedded device having a second execution environment which is different from the first environment of the computing device, wherein the transforming comprises transforming weights or activation values in a model from a format of a first bit precision supported by the first execution environment to a format of a second bit precision supported by the second execution environment, where a value of the first bit precision is greater than a value of the second bit precision; synchronizing the second artificial intelligence model and a dataset stored on the computing device with a network storage module connected via a network to the computing device and the embedded device, wherein the synchronized dataset and the synchronized second artificial intelligence model are accessible by both the computing device and the embedded device; requesting the embedded device to perform inference of the synchronized second artificial intelligence model using the synchronized dataset in the second execution environment, and receiving first result data according to the performance of the inference from the embedded device; and training, by the computing device, the second artificial intelligence model to be executed on the embedded device, using the first result data, and wherein the requesting the embedded device to perform the inference of the synchronized second artificial intelligence model using the synchronized dataset in the second execution environment comprises: transmitting an initialization request for a driver to perform inference on the embedded device and an inference request signal including path information of the synchronized dataset on the network storage module, to the embedded device.

According to an exemplary embodiment of the present disclosure, a computing device efficiently trains an artificial intelligence model executable on an embedded device in which resources are limited to provide an artificial intelligence model trained to operate on the embedded device.

According to an exemplary embodiment of the present disclosure, a technique for flexibly and efficiently performing, by the computing device, development of the artificial intelligence model on the embedded device can be provided.

Effects which can be acquired in the present disclosure are not limited to the aforementioned effects and other unmentioned effects will be clearly understood by those skilled in the art from the following description.

### BRIEF DESCRIPTION OF THE SEVERAL VIEWS OF THE DRAWINGS

Various aspects are now described with reference to the drawings and like reference numerals are generally used to designate like elements. In the following exemplary embodiments, for purposes of explanation, numerous specific details are set forth to provide a comprehensive understanding of one or more aspects. However, it will be apparent that the aspect(s) can be executed without the detailed matters.

FIG. 1 is a diagram for describing a system for training an artificial intelligence model executable on an embedded device according to an exemplary embodiment of the present disclosure.

FIG. 2 is a diagram illustrates an exemplary structure of an artificial intelligence model according to an exemplary embodiment of the present disclosure.

FIG. 3 is a diagram illustrating a method for training an artificial intelligence model executable on an embedded device according to an exemplary embodiment of the present disclosure.

FIG. 4 is a diagram schematically illustrating a computing device for training an artificial intelligence model executable on an embedded device, and the embedded device according to an exemplary embodiment of the present disclosure.

FIG. 5 is a diagram schematically illustrating a computing device for training an artificial intelligence model executable on an embedded device, and the embedded device according to another exemplary embodiment of the present disclosure.

FIG. 6 is a diagram illustrating a process of applying a flatten to each of a plurality of result data according to an exemplary embodiment of the present disclosure.

FIG. 7 is a diagram illustrating a process of applying sorting to each of the plurality of result data to which the flatten is applied according to an exemplary embodiment of the present disclosure.

FIG. 8 is a diagram illustrating a process of calculating a similarity between the plurality of result data to which the flatten and the alignment are applied according to an exemplary embodiment of the present disclosure.

FIG. 9 illustrates a simple and general schematic view of an exemplary computing environment in which the exemplary embodiments of the present disclosure may be implemented.

### DETAILED DESCRIPTION

Various exemplary embodiments will now be described with reference to drawings. In this specification, various descriptions are presented to provide appreciation of the present disclosure. However, it is apparent that the exemplary embodiments can be executed without the specific description.

“Component,” “module,” “system,” and the like which are terms used in the specification refer to a computer-related entity, hardware, firmware, software, and a combination of the software and the hardware, or execution of the software. For example, the component may be a processing executed on a processor, the processor, an object, an execution thread, a program, and/or a computer, but is not limited thereto. For example, both an application executed in a computing device and the computing device may be the components. One or more components may reside within the processor and/or an execution thread. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

In addition, the term “or” is intended to mean not exclusive “or” but implicit “or.” That is, when not separately specified or not clear in terms of a context, a sentence “X uses A or B” is intended to mean one of the natural inclusive replacements. That is, the sentence “X uses A or B” may be applied to any of the case where X uses A, the case where X uses B, or the case where X uses both A and B. Further, it should be understood that the terms “or” and “and/or” used in this specification designates and includes all available combinations of one or more items among enumerated related items.

Further, it should be appreciated that the term “comprises” and/or “comprising” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

In addition, the term “at least one of A or B” should be interpreted to mean “a case including only A,” “a case including only B,” and “a case in which A and B are combined.”

Those skilled in the art need to recognize that various illustrative logical blocks, configurations, modules, circuits, means, logic, and algorithm steps described in connection with the exemplary embodiments disclosed herein may be additionally implemented as electronic hardware, computer software, or combinations of both sides. To clearly illustrate the interchangeability of hardware and software, various illustrative components, blocks, configurations, means, logic, modules, circuits, and steps have been described above generally in terms of their functionalities. Whether the functionalities are implemented as the hardware or software depends on a specific application and design restrictions given to an entire system. Skilled artisans may implement the described functionalities in various ways for each particular application. However, such implementation decisions should not be interpreted as causing a departure from the scope of the present disclosure.

The description of the presented exemplary embodiments is provided so that those skilled in the art of the present disclosure use or implement the present disclosure. Various modifications to the exemplary embodiments will be apparent to those skilled in the art. Generic principles defined herein may be applied to other exemplary embodiments without departing from the scope of the present disclosure. Therefore, the present disclosure is not limited to the exemplary embodiments presented herein. The present disclosure should be analyzed within the widest range which is coherent with the principles and new features presented herein.

In the present disclosure, terms represented by N-th such as first, second, or third are used for distinguishing at least one entity. For example, entities expressed as first and second may be the same as each other or different from each other.

In addition, the term “etc.” such as “A, B, etc.,” should be interpreted to mean “a case including only A,” “a case including only B,” and “a case in which A and B are combined.”

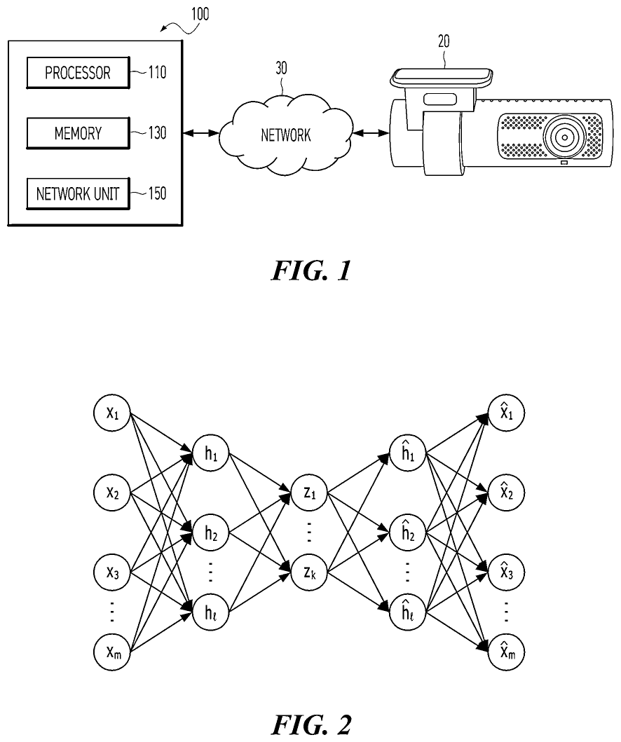

FIG. 1 is a diagram for describing a system for training an artificial intelligence model executable on an embedded device according to an exemplary embodiment of the present disclosure.

Referring to FIG. 1, the system for training an artificial intelligence model executable on an embedded device may include a computing device 100, an embedded device 20, a network 30, etc.

The computing device 100 may include a processor 110, a memory 130, and a network unit 150. The constitution of the computing device 100 is an example schematically illustrated, and an additional component may be included in the computing device 100, or some of the components of the computing device 100 may be excluded or replaced.

In an exemplary embodiment, the computing device 100 may mean a device for training the artificial intelligence model executable on the embedded device 20.

In an exemplary embodiment, the computing device 100 may mean a device used for performing a validation check for the artificial intelligence model executable on the embedded device 20.

In an exemplary embodiment, the computing device 100 may include a training server, a separate development device different from the training server, a network storage server (e.g., a network file system (NFS) server, etc.). In an exemplary embodiment, the training server, the development device, and/or the network storage server may be used as a meaning that encompasses any type of server and any type of terminal.

In an exemplary embodiment, the training server may perform training of the artificial intelligence model. For example, the training server may train an artificial intelligence model corresponding to an execution environment of the computing device 100. The training server may transmit the trained artificial intelligence model to a development device.

In an exemplary embodiment, the development device may receive the trained artificial intelligence model from the training server. The development device may transform the trained artificial intelligence model into an artificial intelligence model corresponding to the execution environment of the embedded device 20. The development device may synchronize the transformed artificial intelligence model and a dataset on the network storage server. The development device may request the embedded device 20 to perform inference of the synchronized artificial intelligence model by using the synchronized dataset on the network storage server. The development device may receive result data according to the inference of the synchronized artificial intelligence model from the embedded device 20. The development device may transmit the result data to the training server. The development device may transform the result data to correspond to the execution environment of the computing device 100 when the result data corresponds to the execution environment of the embedded device 20.

In an exemplary embodiment, the training server may update a loss of the artificial intelligence model corresponding to the execution environment of the computing device 100 by using the result data received from the development device. The training server may transmit information on the updated loss to the development device.

In an exemplary embodiment, the development device may receive the information on the updated loss from the training server. The development device may update weights of the artificial intelligence model corresponding to the execution environment of the embedded device 20 based on the information on the updated loss.

In an exemplary embodiment, the network storage server may be a server which shares stored data. The network storage server may be connected to another server (e.g., the training server, the development device, etc.) and the embedded device 20 included in the computing device 100 through the network. The network storage server may permit an access of data stored in another server and the embedded device 20 included in the computing device 100. Accordingly, another server and the embedded device 20 included in the computing device 100 synchronize the data on the network storage server to share the data.

In an exemplary embodiment, the processor 110 may be constituted by one or more cores and may include processors which perform operations associated with processing of data, such as a central processing unit (CPU), a general purpose graphics processing unit (GPGPU), and a tensor processing unit (TPU) of the computing device 100, and the like.

In an exemplary embodiment, the processor 110 may also perform a computation for learning a neural network. For example, the processor 110 may perform calculations for learning the neural network, which include processing of input data for learning in deep learning (DL), extracting a feature in the input data, calculating an error, updating weights of the neural network using backpropagation, and the like. At least one of the CPU, GPGPU, and TPU of the processor 110 may process learning of a network function. For example, both the CPU and the GPGPU may perform the learning of the network function and data processing using the network function. Further, in an exemplary embodiment of the present disclosure, processors of the plurality of computing devices may be used together to perform the learning of the network function and the data processing using the network function.

The processor 110 may generally control an overall operation of the computing device 100. The processor 110 processes a signal, data, information, and the like input or output through the components included in the computing device 100 or drives the application program stored in the memory 130 to provide or process information or a function appropriate for the user.

In an exemplary embodiment, the memory 130 may store any type of information generated or determined by the processor 110 and/or any type of information received by the network unit 150.

In an exemplary embodiment, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and/or an optical disk. The computing device 100 may operate in connection with a web storage performing a storing function of the memory 130 on the Internet. The description of the memory is just an example and the present disclosure is not limited thereto. The memory 130 may be operated by the processor 110.

In an exemplary embodiment, the memory 130 may include the network storage server. The memory 130 may store, in the network storage server, data stored, obtained, and/or generated by the computing device 100. For example, the memory 130 may store the dataset, and/or the artificial intelligence model in the network storage server.

In an exemplary embodiment, in the network unit 150, an arbitrary wired/wireless communication network that may transmit and receive arbitrary type data and signals may be included in the network expressed in the present disclosure. The techniques described in this specification may also be used in other networks in addition to the aforementioned networks.

In an exemplary embodiment, the network unit 150 may be able to communicate with the network storage server. The network unit 150 communicates with the network storage server to access the data stored in the network storage server.

In the present disclosure, the computing device 100 may be used as a meaning that encompasses any type of server and any type of terminal.

In an exemplary embodiment, the server may include, for example, any type of computing system or computing device such as a microprocessor, a mainframe computer, a digital processor, a portable device, and a device controller.

In an exemplary embodiment, the server may include a storage unit for storing data and/or information used in the present disclosure. The storage unit may be included in the server, or may be present under the management of the server. As another example, the storage unit may also be present outside the server, and implemented in a form which is capable of communicating with the server. In this case, the storage unit may be managed and controlled by another external server different from the server. The storage unit may be used interchangeably with the memory 130.

In an exemplary embodiment, the terminal may include any type of terminal which is capable of interacting with the server or another computing device. For example, the terminal may include a mobile phone, a smart phone, a laptop computer, personal digital assistants (PDA), a slate PC, a tablet PC, an Ultrabook, etc.

The embedded device 20 as an electronic device designed for a specific purpose may mean a type in which hardware and software are combined to perform a specific function. For example, the embedded device 20 may include a smartphone, an Internet of things (IoT) device, a monitoring camera, etc.

In an exemplary embodiment, the execution environment (e.g., a quantization algorithm of the NPU, etc.) of the embedded device 20 may be different from the execution environment of the computing device 100. The execution environment of the embedded device 20 may have a structure which may not be recognized by the computing device 100. For example, a function of quantizing to be compatible with the execution environment of the embedded device 20 may be performed by using an API provided by a manufacturer of the embedded device 20. Even though the API is used, information on which quantization parameter is used or applied is not opened, so the quantization parameter and/or quantization algorithm of the embedded device 20 may not be recognized by the computing device 100.

In an exemplary embodiment, the embedded device 20 may also perform the data processing using the network function.

The embedded device 20 may perform a validation check for the artificial intelligence model executable on the embedded device 20.

In an exemplary embodiment, the embedded device 20 may include the processor, the memory, the network unit, etc.

In an exemplary embodiment, the processor of the embedded device 20 may be constituted by one or more cores, and may include a processor for performing an operation associated with processing of data, such as a neural processing unit (NPU), etc.

The processor of the embedded device 20 may generally control an overall operation of the embedded device 20. The processor of the embedded device 20 processes a signal, data, information, and the like input or output through the components included in the embedded device 20 or drives the application program stored in the memory of the embedded device 20 to provide or process information or a function appropriate for the user.

In an exemplary embodiment, the memory of the embedded device 20 may store any type of information generated or determined by the processor of the embedded device 20 and/or any type of information received by the network unit of the embedded device 20.

In an exemplary embodiment, the memory of the embedded device 20 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and/or an optical disk. The embedded device 20 may operate in connection with a web storage performing a storing function of the memory of the embedded device 20 on the Internet. The description of the memory is just an example and the present disclosure is not limited thereto. The memory of the embedded device 20 may be operated by the processor of the embedded device 20.

In an exemplary embodiment, the memory of the embedded device 20 may include the network storage server. The memory of the embedded device 20 may store, in the network storage server, data stored, acquired, and/or generated by the embedded device 20. For example, the memory of the embedded device 20 may store result data according to inference of the artificial intelligence model in the network storage server.

In an exemplary embodiment, in the network unit of the embedded device 20, an arbitrary wired/wireless communication network that may transmit and receive arbitrary type data and signals may be included in the network expressed in the present disclosure.

In an exemplary embodiment, the network unit of the embedded device 20 may be able to communicate with the network storage server. The network unit of the embedded device 20 communicates with the network storage server to access the data stored in the network storage server.

The network 30 may include an arbitrary wired/wireless communication network that may transmit/receive arbitrary type data and signals. For example, the network 30 may include a wired/wireless communication network which may transmit and receive data including the artificial intelligence model, the result, data, etc., between the computing device 100 and the embedded device 20.

FIG. 2 is a diagram illustrates an exemplary structure of an artificial intelligence model according to an exemplary embodiment of the present disclosure.

Throughout this specification, the artificial intelligence model, an artificial intelligence based model, a computation model, the neural network, a network function, and the neural network may be used as the same meaning.

The neural network may be generally constituted by an aggregate of calculation units which are mutually connected to each other, which may be called nodes. The nodes may also be called neurons. The neural network is configured to include one or more nodes. The nodes (alternatively, neurons) constituting the neural networks may be connected to each other by one or more links.

In the neural network, one or more nodes connected through the link may relatively form the relationship between an input node and an output node. Concepts of the input node and the output node are relative and a predetermined node which has the output node relationship with respect to one node may have the input node relationship in the relationship with another node and vice versa. As described above, the relationship of the input node to the output node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable and the weight is variable by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form a relationship of the input node and output node in the neural network. A characteristic of the neural network may be determined according to the number of nodes, the number of links, correlations between the nodes and the links, and values of the weights granted to the respective links in the neural network. For example, when the same number of nodes and links exist and there are two neural networks in which the weight values of the links are different from each other, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed through for reaching the corresponding node from the initial input node. However, definition of the layer is predetermined for description and the order of the layer in the neural network may be defined by a method different from the aforementioned method. For example, the layers of the nodes may be defined by the distance from a final output node.

In an exemplary embodiment of the present disclosure, a set of neurons or nodes may be defined as an expression layer.

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean nodes constituting the neural network other than the initial input node and the final output node.

In the neural network according to an exemplary embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another exemplary embodiment of the present disclosure, the number of nodes of the input layer may be smaller than the number of nodes of the output layer, and the neural network may be a neural network of a type in which the number of nodes increases from the input layer to the hidden layer. Further, in the neural network according to yet another exemplary embodiment of the present disclosure, the number of nodes of the input layer may be larger than the number of nodes of the output layer, and the neural network may be a neural network of a type in which the number of nodes decreases from the input layer to the hidden layer. The neural network according to still yet another exemplary embodiment of the present disclosure may be a neural network of a type in which the neural networks are combined.

The artificial intelligence based model according to an exemplary embodiment of the present disclosure may include a deep neural network (DNN). The deep neural network may mean a neural network including a plurality of hidden layers other than the input layer and the output layer. When the deep neural network is used, the latent structures of data may be determined. That is, latent structures of photos, text, video, voice, a protein sequence structure, a gene sequence structure, a peptide sequence structure, music (e.g., what objects are in the photo, what the content and feelings of the text are, what the content and feelings of the voice are), and/or a binding affinity between the peptide and MHC may be determined. The deep neural network may include a convolutional neural network (CNN), a recurrent neural network (RNN), an auto encoder, a restricted Boltzmann machine (RBM), a deep belief network (DBN), a Q network, a U network, a Siam network, a Generative Adversarial Network (GAN), a transformer, and the like. The description of the deep neural network described above is just an example and the present disclosure is not limited thereto.

The artificial intelligence based model of the present disclosure may be expressed by a network structure with the any structure, which includes the input layer, the hidden layer, and the output layer.

The neural network which may be used in the artificial intelligence based model of the present disclosure may be learned in at least one scheme of supervised learning, unsupervised learning, semi supervised learning, transfer learning, active learning, or reinforcement learning. The learning of the neural network may be a process in which the neural network applies knowledge for performing a specific operation to the neural network.

The neural network may be learned in a direction to minimize errors of an output. The learning of the neural network is a process of repeatedly inputting learning data into the neural network and calculating the output of the neural network for the learning data and the error of a target and back-propagating the errors of the neural network from the output layer of the neural network toward the input layer in a direction to reduce the errors to update the weight of each node of the neural network. In the case of the supervised learning, the learning data labeled with a correct answer is used for each learning data (i.e., the labeled learning data) and in the case of the unsupervised learning, the correct answer may not be labeled in each learning data. That is, for example, the learning data in the case of the supervised learning associated with the data classification may be data in which category is labeled in each learning data. The labeled learning data is input to the neural network, and the error may be calculated by comparing the output (category) of the neural network with the label of the learning data. As another example, in the case of the unsupervised learning associated with the data classification, the learning data as the input is compared with the output of the neural network to calculate the error. The calculated error is back-propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a learning cycle (epoch). The learning rate may be applied differently according to the number of repetition times of the learning cycle of the neural network. For example, in an initial stage of the learning of the neural network, the neural network ensures a certain level of performance quickly by using a high learning rate, thereby increasing efficiency and uses a low learning rate in a later stage of the learning, thereby increasing accuracy.

In learning of the neural network, the learning data may be generally a subset of actual data (i.e., data to be processed using the learned neural network), and as a result, there may be a learning cycle in which errors for the learning data decrease, but the errors for the actual data increase. Overfitting is a phenomenon in which the errors for the actual data increase due to excessive learning of the learning data. For example, a phenomenon in which the neural network that learns a cat by showing a yellow cat sees a cat other than the yellow cat and does not recognize the corresponding cat as the cat may be an example of overfitting. The overfitting may act as a cause which increases the error of the machine learning algorithm. Various optimization methods may be used in order to prevent the overfitting. In order to prevent the overfitting, a method such as increasing the learning data, regularization, dropout of omitting a part of the node of the network in the process of learning, utilization of a batch normalization layer, etc., may be applied.

Disclosed is a computer readable medium storing the data structure according to an exemplary embodiment of the present disclosure. The above-described data structure may be stored in the storage unit in the present disclosure, executed by the processor, and transmitted and received by the communication unit.

The data structure may refer to the organization, management, and storage of data that enables efficient access to and modification of data. The data structure may refer to the organization of data for solving a specific problem (e.g., data analysis, data search, data storage, data modification). The data structures may be defined as physical or logical relationships between data elements, designed to support specific data processing functions. The logical relationship between data elements may include a connection relationship between data elements that the user defines. The physical relationship between data elements may include an actual relationship between data elements physically stored on a computer-readable storage medium (e.g., persistent storage device). The data structure may specifically include a set of data, a relationship between the data, a function which may be applied to the data, or instructions. Through an effectively designed data structure, a computing device can perform operations while using the resources of the computing device to a minimum. Specifically, the computing device can increase the efficiency of operation, read, insert, delete, compare, exchange, and search through the effectively designed data structure.

The data structure may be divided into a linear data structure and a non-linear data structure according to the type of data structure. The linear data structure may be a structure in which only one data is connected after one data. The linear data structure may include a list, a stack, a queue, and a deque. The list may mean a series of data sets in which an order exists internally. The list may include a linked list. The linked list may be a data structure in which data is connected in a scheme in which each data is linked in a row with a pointer. In the linked list, the pointer may include link information with next or previous data. The linked list may be represented as a single linked list, a double linked list, or a circular linked list depending on the type. The stack may be a data listing structure with limited access to data. The stack may be a linear data structure that may process (e.g., insert or delete) data at only one end of the data structure. The data stored in the stack may be a data structure (LIFO-Last in First Out) in which the data is input last and output first. The queue is a data listing structure that may access data limitedly and unlike a stack, the queue may be a data structure (FIFO-First in First Out) in which late stored data is output late. The deque may be a data structure capable of processing data at both ends of the data structure.

The non-linear data structure may be a structure in which a plurality of data are connected after one data. The non-linear data structure may include a graph data structure. The graph data structure may be defined as a vertex and an edge, and the edge may include a line connecting two different vertices. The graph data structure may include a tree data structure. The tree data structure may be a data structure in which there is one path connecting two different vertices among a plurality of vertices included in the tree. That is, the tree data structure may be a data structure that does not form a loop in the graph data structure.

Throughout this specification, the artificial intelligence based model, the computation model, the neural network, the network function, and the neural network may be used as meanings which are interchangeable with each other. Hereinafter, the artificial intelligence based model, the computation model, the neural network, the network function, and the neural network will be integrated and described as the neural network. The data structure may include the neural network. In addition, the data structures, including the neural network, may be stored in a computer readable medium. The data structure including the neural network may also include data preprocessed for processing by the neural network, data input to the neural network, weights of the neural network, hyper parameters of the neural network, data obtained from the neural network, an active function associated with each node or layer of the neural network, and a loss function for training the neural network. The data structure including the neural network may include predetermined components of the components disclosed above. In other words, the data structure including the neural network may include all of data preprocessed for processing by the neural network, data input to the neural network, weights of the neural network, hyper parameters of the neural network, data obtained from the neural network, an active function associated with each node or layer of the neural network, and a loss function for training the neural network or a predetermined combination thereof. In addition to the above-described configurations, the data structure including the neural network may include predetermined other information that determines the characteristics of the neural network. In addition, the data structure may include all types of data used or generated in the calculation process of the neural network, and is not limited to the above. The computer readable medium may include a computer readable recording medium and/or a computer readable transmission medium. The neural network may be generally constituted by an aggregate of calculation units which are mutually connected to each other, which may be called nodes. The nodes may also be called neurons. The neural network is configured to include one or more nodes.

The data structure may include data input into the neural network. The data structure including the data input into the neural network may be stored in the computer readable medium. The data input to the neural network may include learning data input in a neural network learning process and/or input data input to a neural network in which learning is completed. The data input to the neural network may include preprocessed data and/or data to be preprocessed. The preprocessing may include a data processing process for inputting data into the neural network. Therefore, the data structure may include data to be preprocessed and data generated by preprocessing. The data structure is just an example and the present disclosure is not limited thereto.

The data structure may include weights of the neural network (weights and parameters may be used as meanings which are interchangeable with each other in the present disclosure). In addition, the data structures, including the weight of the neural network, may be stored in the computer readable medium. The neural network may include a plurality of weights. The weight may be variable and the weight is variable by a user or an algorithm in order for the neural network to perform a desired function. For example, when one or more input nodes are mutually connected to one output node by the respective links, the output node may determine a data value output from an output node based on values input in the input nodes connected with the output node and the weights set in the links corresponding to the respective input nodes. The data structure is just an example and the present disclosure is not limited thereto.

As a non-limiting example, the weight may include a weight which varies in the neural network learning process and/or a weight in which neural network learning is completed. The weight which varies in the neural network learning process may include a weight at a time when a learning cycle starts and/or a weight that varies during the learning cycle. The weight in which the neural network learning is completed may include a weight in which the learning cycle is completed. Accordingly, the data structure including the weights of the neural network may include a data structure including the weights which vary in the neural network learning process and/or the weights in which neural network learning is completed. Accordingly, the above-described weight and/or a combination of each weight are included in a data structure including a weight of a neural network. The data structure is just an example and the present disclosure is not limited thereto.

The data structure including the weights of the neural network may be stored in the computer-readable storage medium (e.g., memory, hard disk) after a serialization process. Serialization may be a process of storing data structures on the same or different computing devices and later reconfiguring the data structure and transforming the data structure to a form that may be used. The computing device may serialize the data structure to send and receive data over the network. The data structure including the weights of the serialized neural network may be reconfigured in the same computing device or another computing device through deserialization. The data structure including the weights of the neural network is not limited to the serialization. Furthermore, the data structure including the weights of the neural network may include a data structure (for example, B-Tree, R-Tree, Trie, m-way search tree, AVL tree, and Red-Black Tree in a nonlinear data structure) to increase the efficiency in the operation while using resources of the computing device to a minimum. The above-described matter is just an example and the present disclosure is not limited thereto.

The data structure may include hyper-parameters of the neural network. In addition, the data structures, including the hyper-parameters of the neural network, may be stored in the computer readable medium. The hyper-parameter may be a variable which may be varied by the user. The hyper-parameter may include, for example, a learning rate, a cost function, the number of learning cycle iterations, weight initialization (for example, setting a range of weight values to be subjected to weight initialization), and Hidden Unit number (e.g., the number of hidden layers and the number of nodes in the hidden layer). The data structure is just an example and the present disclosure is not limited thereto.

The artificial intelligence based model according to an exemplary embodiment of the present disclosure may include a large language model (LLM). The large language model in the present disclosure may mean an artificial intelligence based model trained by using a vast amount of learning data to perform natural language processing. The large language model may include the transformer, an encoder-series model of the transformer, and/or a decoder-series model of the transformer. The encoder-series model of the transformer may correspond to an artificial intelligence model using an encoder structure of the transformer. The decoder-series model of the transformer may correspond to an artificial intelligence model using a decoder structure of the transformer.

In an exemplary embodiment, the transformer may be constituted by an encoder that encodes input data and a decoder that decodes the encoded data. The transformer may have a structure which inputs a series of input data, and outputs a series of output data through encoding and decoding steps. In an exemplary embodiment, the series of input data may be processed in a form which is enabled to be computed by the transformer. A process of processing the series of input data in the form which is enabled to be computed by the transformer may include a tokenizing process and an embedding process. The tokenizing process may mean a process of dividing the series of input data into tokens of a predetermined unit. For example, the predetermined unit may include a word unit. The embedding process may mean a process of transforming at least one token tokenized from the series of input data into an embedding vector.

In an exemplary embodiment, the transformer may acquire an embedding vector to be input into the encoder by combining a token embedding vector which embeds at least one token corresponding to the series of input data, a segment embedding vector which segments a sentence including a token for each token, and a position embedding vector to which a position of the token is reflected. The encoder-series model and the decoder-series model of the transformer may also acquire the embedding vector by performing the same scheme.

In an exemplary embodiment, in order for the transformer to encode and decode a series of input data, the encoder and the decoder within the transformer may utilize an attention algorithm. The attention algorithm may mean an algorithm that calculates a similarity by applying a SoftMax function to an attention score acquired by a matrix product of a query and a key with respect to a given query, and calculates an attention value for the query by a matrix product of the calculated similarity and a value.

In an exemplary embodiment, a self-attention algorithm may mean an attention algorithm that uses the query, the key, and the value generated by multiplying the same embedding vector by each of a query weight, a key weight, and a value weight. A cross attention algorithm may mean an attention algorithm that uses a query generated by multiplying a first embedding vector by the query weight, and a key and a value generated by multiplying a second embedding vector by the key weight and the value weight, respectively. The query weight, the key weight, and the value weight may be trainable parameters which are updated through a training process of a large language model.

In an exemplary embodiment, the encoder of the transformer may include an embedding layer, a self-attention layer in which the self-attention algorithm is applied to the embedding vector, a normalization layer, and a feed forward neural network (FNN). Further, the encoder may have a form in which N unit structures including the self-attention layer, the normalization layer, and the feed forward neural network are connected. The decoder of the transformer may include the embedding layer, a masked self-attention layer, the normalization layer, a cross attention layer to which the cross attention algorithm is applied, and the feed forward neural network. Further, the decoder may have a form in which N unit structures including the masked self-attention layer, the normalization layer, the cross attention layer, and the feed forward neural network are connected. The masked self-attention layer may correspond to a layer that obtains attention value each of the sequences sequentially including words in a plurality of words included in the series of input data.

The transformer may also include additional components such as a linear layer, a SoftMax layer, etc., in addition to the encoder and the decoder. Each of the encoder-series model of the transformer and the decoder-series model of the transformer may also include the additional components in addition to the encoder and the decoder. A method for constituting the transformer by using the attention algorithm may include a method disclosed in Vaswani et al., Attention Is All You Need, 2017 NIPS, which is incorporated herein by reference.

In an exemplary embodiment, the attention layer such as the self-attention layer, the masked self-attention layer, the cross attention layer, etc., may correspond to a multi-head attention layer including a plurality of attention layers in parallel. The multi-head attention layer matrix-concatenates attention values output from the plurality of attention layers, respectively, and matrix-multiplies the concatenated matrix by an output weight to output an output attention value. An output attention value output from the multi-head attention layer may have the same size as an attention value output from one attention layer.

In an exemplary embodiment, the transformer may be trained through a masked language model (MLM) process, a next sentence prediction (NSP) process, etc. The MLM process may mean a training process that predicts a masked word through a series of training data in which some words are masked. The NSP process may mean a training process that discriminates whether two sentences are concatenated in a series of training data including any two sentences.

In an exemplary embodiment, the large language model may process various data formats including image data, audio data, video data, etc., in addition to a natural language text. In order to transform data with various data formats into a series of data that are computable, the large language model may embed the data. The large language model may process additional data expressing a relative positional relationship or phase relationship between a series of input data. Alternatively, the series of input data may be embedded by additionally reflecting vectors expressing relative positional relationships or phase relationships between the input data. In one example, the relative positional relationship between a series of input data may include a word order within the natural language sentence, a relative positional relationship of respective segmented images, a temporal order of segmented audio waveforms, etc., but is not limited thereto. A process of adding information expressing a relative positional relationship or phase relationship between a series of input data may be referred to as positional encoding.

One example (Vision Transformer, ViT) of the large language model which processes image data is disclosed in Dosovitskiy, et al., AN IMAGE IS WORTH 16×16 WORDS: TRANSFORMERS FOR IMAGE RECOGNITION AT SCALE, which is incorporated herein by reference.

The artificial intelligence model according to an exemplary embodiment of the present disclosure may include a multi-modal large language model. The multi-modal large language model may mean a large language model that may understand and process a relationship between different data formats including natural language text data, image data, audio data, video data, etc. The multi-modal language model may include a plurality of encoders which encode input data corresponding to each data format. The multi-modal language model may be trained to calculate a similarity between embedding vectors encoded from the encoder, which have respective data formats through training data including data with different data formats, calculate a similarity for the same pair to be higher, and calculate a similarity for different pairs to be lower.

One example (Contrastive Language-Image Pre-training, CLIP) of the multi-modal large language model which understands and processes the relationship between the image data and the natural language text data is disclosed in Alec Radford, et al., LEARNING TRANSFERABLE VISUAL MODELS FROM NATURAL LANGUAGE SUPERVISION, which is incorporated herein by reference.

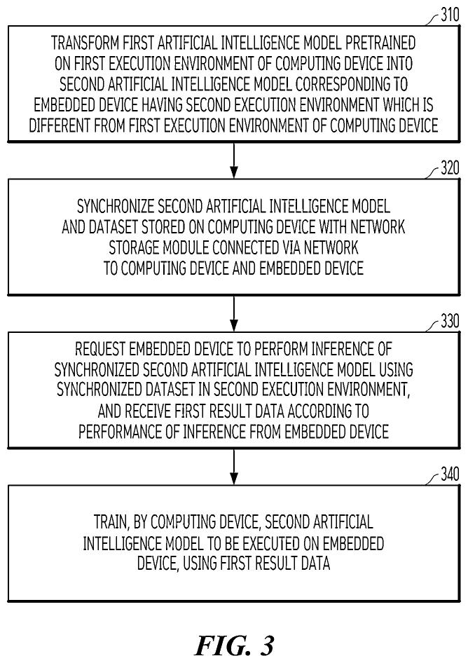

FIG. 3 is a diagram illustrating a method for training an artificial intelligence model executable on an embedded device according to an exemplary embodiment of the present disclosure. According to an implementation aspect, some of steps illustrated in FIG. 3 may be omitted, or an additional step may also be included.

Hereinafter, an exemplary methodology which allows the computing device 100 to train the artificial intelligence model executable on the embedded device 20 is presented.

Referring to FIG. 3, the processor 110 of the computing device 100 may transform a first artificial intelligence model pretrained on a first execution environment of the computing device 100 into a second artificial intelligence model corresponding to the embedded device 20 having a second execution environment different from the computing device 100 (310).

In the present disclosure, the execution environment (e.g., the first execution environment, the second execution environment, etc.) may mean an environment in which a program is executed. For example, the execution environment may include a hardware platform, an operating system, a runtime library, a network environment, etc.

In an exemplary embodiment, the first execution environment may include a computing execution environment which is enabled to be operate by at least one of a central processing unit (CPU) or a graphic processing unit (GPU).

In an exemplary embodiment, the second execution environment may include a computing execution environment which is enabled to operate by a neural processing unit (NPU).

The execution environment in the present disclosure may represent a combination of a software environment and a hardware environment required for developing, training, distributing, and/or operating the artificial intelligence model. The execution environment may include the hardware environment such as a CPU, a GPU, a TPU, a memory, and/or a storage. The execution environment may include the software environment including a development operating system such as Linux, Windows, MacOS, etc., a framework such as TensorFlow, PyTorch, Keras, and/or Scikit-learn, and/or development tools such as Jupyter Notebook, integrated development environment (IDE), etc.

The execution environment in the present disclosure being different may mean that the software environment and/or the hardware environment are different.

In an exemplary embodiment, transformation may mean changing the model to be suitable for a different execution environment. For example, the transformation may include lightweighting the model to be suitable for the different environment. For example, the transformation may include quantizing the model to a different type. Quantization may be used to reduce a computation amount and a memory usage by expressing a weight and an activation value of the model with a numerical value with low precision. For example, the transformation may include transforming a format of a first bit precision which supports the weights or the activation value of the model on the first execution environment into a format of a second bit precision which supports the weights or the activation value of the model on the second execution environment.

As a non-limiting example, the quantization in the present disclosure may include static quantization that transforms the weights and the activation value of the model into a fixed quantization scale, dynamic quantization that quantizes and transforms the activation value at an execution time of the model, post-training quantization that trains the model, and then quantizes and transforms the trained model, and/or quantization-aware training that reflects and transforms a quantization effect in a training process of the model.

In the present disclosure, the bit precision (e.g., the first bit precision, the second bit precision, etc.) may mean a detail of data expressed. In the present disclosure, the bit precision may mean the number of bits used to express bit specific information (e.g., numbers and/or characters). In general, in the artificial intelligence model, a 32-bit floating point number is used, but the 32-bit floating point number is transformed into a lower bit precision such as 16 bits, 8 bits, 4 bits, or 1 bit through quantization to transform the model to be operable in a specific execution environment.

In an exemplary embodiment, a value of the first bit precision may be greater than a value of the second bit precision.

In an exemplary embodiment, a format of the first bit precision may be at least one floating point format of 16 bits, 32 bits, or 64 bits.

In an exemplary embodiment, the format of the second bit precision may be an 8-bit integer format.

In an exemplary embodiment, the first artificial intelligence model may be located in a storage space (e.g., the memory 130, etc.) of the computing device 100.

In an exemplary embodiment, the processor 110 may quantize the first artificial intelligence model which is operable in the first execution environment of the computing device 100 into the second artificial intelligence model which is operable in the second execution environment of the embedded device 20, by using an application programming interface (API) for quantizing into the model which is operable in the embedded device 20.

In an exemplary embodiment, the second artificial intelligence model represents the model which is operable in the embedded device 20. The second artificial intelligence model may be impossible to be executed or simulated on the computing device 100. The second artificial intelligence model may be possible to be executed or simulated on the embedded device 20.

In an exemplary embodiment, a quantization algorithm or a quantization parameter on the API may be a structure which is not recognized by the computing device 100.

The processor 110 may synchronize the dataset stored in the computing device 100 and the second artificial intelligence model on the network storage module connected to the computing device 100 and the embedded device 20 through the network 30 (320).

In the present disclosure, the network storage module may be a module which shares stored data. For example, the network storage module may be a module which shares the corresponding data with at least one device which is permitted to access the stored data. The network storage module may permit multiple computing devices to share and access a file.

In an exemplary embodiment, synchronization may mean storing data in the network storage module so that the computing device 100 and the embedded device 20 may share the same dataset and artificial intelligence model. The synchronized dataset and/or second artificial intelligence model may be accessible by both the computing device 100 and the embedded device 20. That is, the computing device 100 synchronizes the dataset and the second artificial intelligence model stored in the computing device 100 with the network storage module, so the embedded device 20 accesses the network storage module to utilize the dataset and the second artificial intelligence model.

In an exemplary embodiment, the second artificial intelligence model and/or the dataset for training the second artificial intelligence model (e.g., the dataset stored in the computing device 100) may be generated or acquired by the computing device 100. For example, the computing device 100 receives the dataset for training the second artificial intelligence model from an external device to acquire the dataset.

The processor 110 may request the embedded device 20 to perform inference of the synchronized second artificial intelligence model by using the dataset synchronized on the second execution environment, and receive the first result data by performing the inference from the embedded device 20 (330).

The embedded device 20 may perform the inference of the synchronized second artificial intelligence model by using the dataset synchronized on the second execution environment according to the request received from the computing device 100. The embedded device 20 performs the inference of the synchronized second artificial intelligence model to acquire the first result data. The embedded device 20 may transmit the first result data to the computing device 100.

In an exemplary embodiment, requesting the embedded device 20 to perform the inference of the synchronized second artificial intelligence model by using the dataset synchronized on the second execution environment may include delivering, to the embedded device 20, an inference request signal including an initialization request of a driver for performing the inference in the embedded device 20 and path information of the dataset synchronized on the network storage module. That is, the processor 110 may deliver, to the embedded device 20, the inference request signal including the initialization request of the driver for performing the inference in the embedded device 20 and the path information of the dataset synchronized on the network storage module.

In an exemplary embodiment, when a performing request of the inference is a performing request of batch inference, the inference request signal may further include batch-specific path information synchronized on the network storage module.

In the present disclosure, the batch may mean data or a task is bundled and processed into a predetermined unit. For example, the batch inference may represent a process in which the artificial intelligence model performs prediction for multiple input data at once. The batch inference as a concept compared to real-time inference may derive a prediction result by processing multiple data at once.

The computing device 100 may train the second artificial intelligence model to be executed in the embedded device 20 by using the first result data (340).

In an exemplary embodiment, the computing device 100 may update a loss of the first artificial intelligence model based on the first result data.

In the present disclosure, updating the loss of the artificial intelligence model may include modifying a weight and/or a bias of the artificial intelligence model in order to reduce the loss by using a backpropagation algorithm. Updating the loss of the artificial intelligence model may mean adjusting the weight and the bias of the model by using a result of a loss function in a process of minimizing a difference between a value predicted by the model and an actual value.

For example, the processor 110 of the computing device 100 may update a loss of the first artificial intelligence model by using a difference between the first result data and ground truth data of the dataset. The first result data may be transformed to correspond to the computing device 100 having the first execution environment by the embedded device 20.

As another example, the processor 110 of the computing device 100 may transform the first result data to correspond to the computing device 100 having the first execution environment, and update the loss of the first artificial intelligence model by using the difference between the transformed first result data and the ground truth data of the dataset.

In an exemplary embodiment, the computing device 100 may update weights of the second artificial intelligence model based on the updated loss of the first artificial intelligence model.

For example, the processor 110 of the computing device 100 transforms the first artificial intelligence model including the updated loss to correspond to the embedded device 20 to generate a 2-bit quantized third artificial intelligence model.

The processor 110 synchronizes the third artificial intelligence model with the network storage module to update the weights of the second artificial intelligence model with weights of the third artificial intelligence model.

As another example, the processor 110 of the computing device 100 may acquire second result data from input data including the dataset by using the first artificial intelligence model.

The processor 110 may calculate a knowledge distillation loss by using a difference between the first result data of the second artificial intelligence model and the second result data of the first artificial intelligence model.

The processor 110 may calculate the loss of the first artificial intelligence model by using a difference between the second result data of the first artificial intelligence model and the ground truth data of the dataset.

The processor 110 reflects the calculated knowledge distillation loss and the loss of the first artificial intelligence model to the first artificial intelligence model to update the loss of the first artificial intelligence model.

The processor 110 may update the weights of the second artificial intelligence model based on the calculated knowledge distillation loss and the loss of the first artificial intelligence model.

Meanwhile, the computing device 100 and/or the embedded device 20 may perform a validation check for the transformed second artificial intelligence model.

For example, the processor 110 of the computing device 100 inputs the same input data into each of the first artificial intelligence model and the second artificial intelligence model to acquire output data of the first artificial intelligence model and output data of the second artificial intelligence model, after the step 310 of transforming the first artificial intelligence model into the second artificial intelligence model.

When it is determined that there is an abnormality associated with the second artificial intelligence model based on a tensor of output data output by inputting the same input data into each of the first artificial intelligence model and the second artificial intelligence model, the processor 110 uses a scheme of changing a shape of a matrix of data to identify a cause of the abnormality associated with the second artificial intelligence model.

The tensor in the present disclosure may represent a basic unit that expresses the data of the artificial intelligence model, and performs computation. In an exemplary embodiment, the tensor as a multi-dimensional array that expresses data may be expressed as a generalized form of the vector and the matrix. The tensor may be used to express the input data, the weight, and the activation value of the model. For example, the tensor may include a scala, the vector, the matrix, etc.

In an exemplary embodiment, the scheme of changing the shape of the matrix of the data may be a scheme of changing the shape of the matrix of the data without performing a separate transformation process of transforming the artificial intelligence model.

In an exemplary embodiment, when the abnormality associated with the second artificial intelligence model is not originated from the shape of the matrix of the data, the processor 110 may determine that there is an error in the transformation itself. Accordingly, when the abnormality associated with the second artificial intelligence model is not originated from the shape of the matrix of the data, the processor 110 may return to the step 310 of transforming the first artificial intelligence model.

In an exemplary embodiment, the processor 110 performs debugging through a chip manufacturer to confirm an error of a framework itself of a neural processing unit. The processor 110 may attempt the quantization again by changing a condition in the process of transforming the first artificial intelligence model into the second artificial intelligence model. The processor 110 searches a human error in a description of the framework of the neural processing unit to confirm an error of the description.

In an exemplary embodiment, the abnormality associated with the second artificial intelligence model may be identified as abnormality when a similarity between the tensors of the output data is less than a predetermined threshold (e.g., 0.7, etc.). That is, the processor 110 may determine that there is the abnormality associated with the second artificial intelligence model when the similarity between the tensors of the output data is less than the predetermined threshold.

In the present disclosure, the similarity may be a numerical value representing a similarity degree between a plurality of data. The similarity may be calculated by using at least one of a plurality of similarity calculation functions. For example, the similarity may be calculated by using a cosine similarity.

As another example, the processor 110 of the computing device 100 may synchronize a dummy dataset for a test, which is stored in the computing device 100 on the network storage module after the step 310 of transforming the first artificial intelligence model into the second artificial intelligence model.

The dummy dataset in the present disclosure may be a dataset created for testing the artificial intelligence model. For example, the dummy dataset may be a dataset created by transforming a part of a training dataset used for training the artificial intelligence model. A structure of the dummy dataset may be a structure corresponding to the training dataset. Data included in the dummy dataset may not be information of actual data, but any created data.

The processor 110 may generate third result data by performing the inference of the first artificial intelligence model by using the dummy dataset on the first execution environment.

The processor 110 may synchronize the generated third result data on the network storage module.

The processor 110 may receive, from the embedded device 20, a validation result of the second artificial intelligence model generated at least partially based on the synchronized dummy dataset and the synchronized third result data.

The validation result in the present disclosure may be information used for determining whether the artificial intelligence model is normal. For example, the validation result may include information on a similarity between result data. When the similarity included in the validation result is less than a predetermined threshold, it may be determined that there is the abnormality in the artificial intelligence model.

In an exemplary embodiment, a validation result of the second artificial intelligence model may be generated by determining a first similarity between fourth result data acquired by performing the inference of the second artificial intelligence model and the synchronized third result data by using the dummy dataset synchronized on the second execution environment by the embedded device 20. That is, the embedded device 20 may acquire the fourth result data by performing the inference of the second artificial intelligence model by using the dummy dataset synchronized on the second execution environment. The embedded device 20 may generate the validation result of the second artificial intelligence model by calculating the first similarity between the fourth result data and the synchronized third result data. For example, the embedded device 20 may calculate the first similarity by using a function of calculating a cosine similarity between the fourth result data and the synchronized third result data. The embedded device 20 may transmit the calculated first similarity to the computing device 100.

For example, the validation result of the second artificial intelligence model may be generated by applying a flatten which transforms each of the third result data and the fourth result data in one dimension to the third result data and the fourth result data, sorting each of the third result data and the fourth result data to which the flatten is applied based on a predetermined reference (e.g., sorting the third result data and the fourth result data in ascending order based on a data size), and determining the first similarity between the sorted third result data and the sorted fourth result data. That is, the embedded device 20 may apply the flatten to the third result data and the fourth result data. The embedded device 20 may sort each of the third result data and the fourth result data to which the flatten is applied based on the predetermined reference. The embedded device 20 may generate the validation result of the second artificial intelligence model by determining the first similarity between the sorted third result data and the sorted fourth result data.

When the first similarity is less than a predetermined threshold, it may be determined that there is the abnormality associated with the second artificial intelligence model. That is, when the first similarity is less than the predetermined threshold, the processor 110 may determine that there is the abnormality associated with the second artificial intelligence model.

When the processor 110 determines that there is the abnormality, the processor 110 may identify the cause of the abnormality associated with the second artificial intelligence model by using the scheme of changing the shape of the matrix of the data.

The processor 110 may generate fifth result data by performing the inference of the first artificial intelligence model by using the dummy dataset on the first execution environment after changing the shape of the matrix of the data.

The processor 110 may synchronize the generated fifth result data on the network storage module.

The processor 110 may receive, from the embedded device 20, a second similarity between sixth result data acquired by performing the inference of the second artificial intelligence model in which the shape of the matrix of the data is changed by using the dummy dataset synchronized on the second execution environment, and the synchronized fifth result data. The embedded device 20 may perform the inference of the second artificial intelligence model in which the shape of the matrix of the data is changed by using the dummy dataset synchronized on the second execution environment. The embedded device 20 performs the inference of the second artificial intelligence model in which the shape of the matrix of the data is changed to acquire the sixth result data. The embedded device 20 may calculate a second similarity between the acquired sixth result data and the synchronized fifth result data. The embedded device 20 may transmit the calculated second similarity to the computing device 100.

The processor 110 may identify the cause of the abnormality based on the second similarity. For example, when the second similarity is equal to or greater than a predetermined threshold (e.g., 0.7, etc.), the processor 110 may determine that the abnormality associated with the second artificial intelligence model is originated from the shape of the matrix of the data.

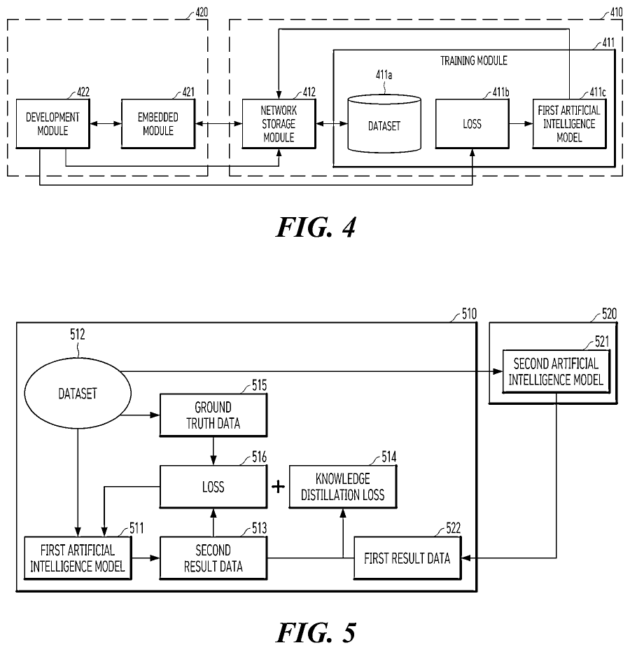

FIG. 4 is a diagram schematically illustrating a computing device for training an artificial intelligence model executable on an embedded device, and the embedded device according to an exemplary embodiment of the present disclosure. Hereinafter, when a detailed description of components disclosed in FIG. 4 (e.g., a computing device 410, an embedded device 420, etc.) disclosed in FIG. 4 is duplicated, the detailed description may be omitted, and may be replaced with the contents described above with reference to FIGS. 1 to 3.

Referring to FIG. 4, in an exemplary embodiment, the computing device 410 may include a training module 411, a network storage module 412, etc. In an exemplary embodiment, the network storage module 412 may not be included in the computing device 410, but may also be present as a separate entity. In this case, the network storage module 412 may be used as a meaning which encompasses any type of server including a storage medium, and any type of terminal.

In an exemplary embodiment, the training module 411 may perform data processing associated with training of the artificial intelligence model.

In an exemplary embodiment, the network storage module 412 may be connected to the computing device 410 and the embedded device 420 through the network. Data stored in the network storage module 412 may be accessible by both the computing device 410 and the embedded device 420.

In an exemplary embodiment, the training module 411 and/or the network storage module 412 may be controlled by the processor of the computing device 410.

In an exemplary embodiment, the embedded device 420 may include an embedded module 421, a development module 422, etc. In an exemplary embodiment, the development module 422 may not be included in the embedded device 420, but may also be present as a separate entity. In this case, the development module 422 may be used as a meaning that encompasses any type of server and any type of terminal.

In an exemplary embodiment, the embedded module 421 may perform the inference of the artificial intelligence model. The embedded module 421 may perform a validation check for the artificial intelligence model executable on the embedded device 420.

In an exemplary embodiment, the development module 422 may receive result data (e.g., result data according to inference performing, result data according to the validation check, etc.) from the embedded module 421. The development module 422 may transform the received result data to correspond to the computing device 410. The development module 422 may transmit the received result data and/or the transformed result data to the computing device 410. For example, the development module 422 may transmit the received result and/or the transformed result to each of the training module 411 and/or the network storage module 412.

In an exemplary embodiment, the embedded module 421 and/or the development module 422 may be controlled by the processor of the embedded device 420.

The training module 411 may transform a first artificial intelligence model 411c pretrained on the first execution environment of the computing device 410 into the second artificial intelligence model.

The training module 411 may synchronize the second artificial intelligence model and a dataset 411a on the network storage module 412.

The training module 411 may request the embedded device 420 to perform the inference of the synchronized second artificial intelligence model by using the synchronized dataset to the network storage module 412.

The embedded module 421 may perform the validation check for the synchronized second artificial intelligence model. For example, the embedded module 421 may perform the validation check for the synchronized second artificial intelligence model when receiving, from the computing device 410, the request for the inference of the synchronized second artificial intelligence model. As another example, the embedded module 421 may perform the validation check for the synchronized second artificial intelligence model when the second artificial intelligence model is synchronized on the network storage module 412.

When it is determined that the synchronized second artificial intelligence model is normal according to the validation check result, the embedded module 421 may perform the inference of the synchronized second artificial intelligence model by using the dataset synchronized on the network storage module 412. The embedded module 421 may acquire first result data according to the performance of the inference. The embedded module 421 may transmit the first result data to the development module 422.

The development module 422 may transmit the first result data to the computing device 410.

The computing device 410 may train the second artificial intelligence model to be executed on the embedded device 420 by using the first result data. For example, the training module 411 may update a loss 411b of a first artificial intelligence model 411c based on the first result data. The training module 411 may update weights of the second artificial intelligence model based on the updated loss 411b of the first artificial intelligence model.

FIG. 5 is a diagram schematically illustrating a computing device for training an artificial intelligence model executable on an embedded device, and the embedded device according to another exemplary embodiment of the present disclosure. Hereinafter, when a detailed description of components (e.g., a computing device 510, an embedded device 520, etc.) disclosed in FIG. 5 is duplicated, the detailed description may be omitted, and may be replaced with the contents described above with reference to FIGS. 1 to 4.

Referring to FIG. 5, the embedded device 520 performs inference of a synchronized second artificial intelligence model 521 by using a dataset 512 synchronized with a network storage module to acquire first result data 522.

The embedded device 520 may transmit the first result data 522 to the computing device 510.

The computing device 510 may acquire second result data 513 from input data including the dataset 512 by using a first artificial intelligence model 511.

The computing device 510 may calculate a knowledge distillation loss 514 by using a difference between the first result data 522 and the second result data 513. For example, knowledge distillation may represent a methodology which transfers a knowledge of a large model (e.g., a teacher model) to a small model (e.g., a student model). The knowledge distillation may be used to acquire an efficient model particularly in an environment in which a resource is limited. The knowledge distillation loss 514 may represent a loss for minimizing a difference between outputs (e.g., prediction distributions) of the teacher model and the student model.

The computing device 510 may calculate a loss 516 of the first artificial intelligence model 511 by using a difference between the second result data 513 and ground truth data 515 of the dataset 512.

The computing device 510 reflects the loss 516 and the knowledge distillation loss 514 to the first artificial intelligence model 511 to update the loss of the first artificial intelligence model 511.

The computing device 510 may update weights of the second artificial intelligence model 521 based on the loss 516 and the knowledge distillation loss 514.

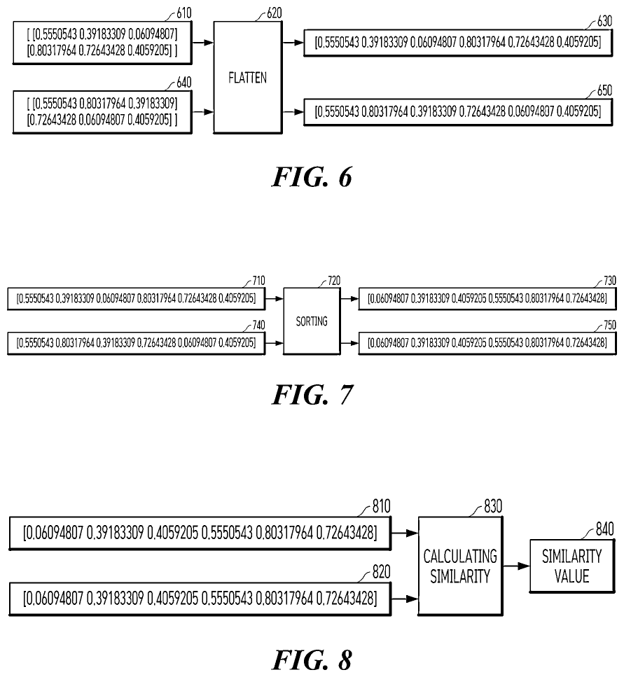

FIG. 6 is a diagram illustrating a process of applying a flatten to each of a plurality of result data according to an exemplary embodiment of the present disclosure.

Referring to FIG. 6, in an exemplary embodiment, the computing device and/or the embedded device applies a flatten 620 to first output data 610 which is result data output by inputting input data into the first artificial intelligence model to generate and/or acquire first output data 630 to which the flatten 620 is applied.

In an exemplary embodiment, the computing device and/or the embedded device applies a flatten 620 to second output data 640 which is result data output by inputting input data into the second artificial intelligence model to generate and/or acquire second output data 650 to which the flatten 620 is applied.

In an exemplary embodiment, the flatten 620 may mean a task of transforming an array and/or a matrix of data to one dimension. For example, the flatten 620 may be a task of transforming 2D data to a 1D vector.

FIG. 7 is a diagram illustrating a process of applying an alignment to each of the plurality of result data to which the flatten is applied according to an exemplary embodiment of the present disclosure.

Referring to FIG. 7, in an exemplary embodiment, the computing device and/or the embedded device sorts first output data 710 to which a flatten is applied based on a predetermined reference (720) to generate and/or obtain the sorted first output data 730.

In an exemplary embodiment, the computing device and/or the embedded device sorts second output data 740 to which a flatten is applied based on a predetermined reference (720) to generate and/or acquire the sorted second output data 750.

In an exemplary embodiment, the predetermined reference may include a reference according to a data size, a reference according to a data type, etc.

FIG. 8 is a diagram illustrating a process of calculating a similarity between the plurality of result data to which the flatten and the sorting are applied according to an exemplary embodiment of the present disclosure.

Referring to FIG. 8, in an exemplary embodiment, the computing device and/or the embedded device performs calculates a similarity between first output data 810 to which a flatten and sorting are applied and second output data 820 to which a flatten and sorting are applied by using at least one of a plurality of similarity calculation functions (830) to acquire a similarity value 840.

As described above with reference to FIGS. 1 to 8, the computing device according to an exemplary embodiment of the present disclosure trains the artificial intelligence model executable on the embedded device having an insufficient storage space by using the network storage module to provide the trained artificial intelligence model to the embedded device.

Further, the computing device according to an exemplary embodiment of the present disclosure may receive result data which is an inference result of the quantized artificial intelligence model from the embedded device, and train the quantized artificial intelligence model by using the received result data even when quantizing the artificial intelligence model by using an API which may not know the quantization algorithm or the quantization parameter.

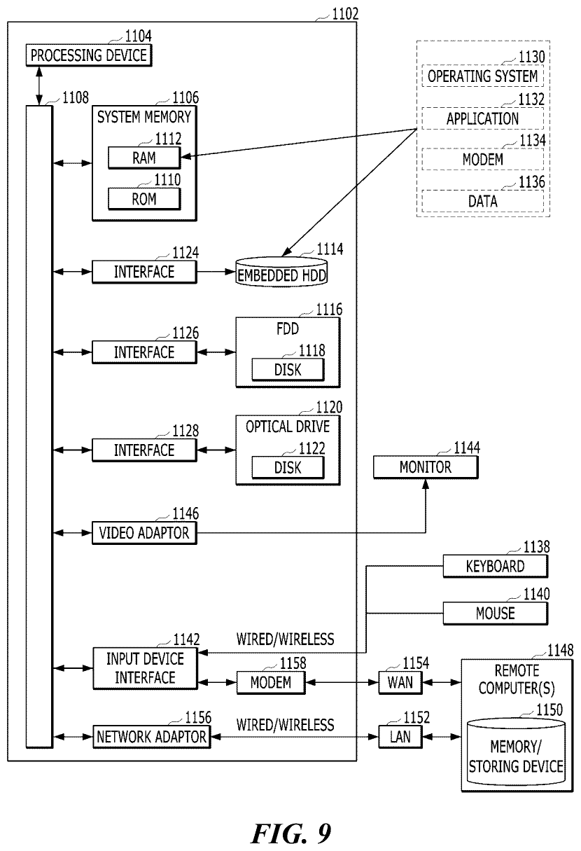

FIG. 9 illustrates a simple and general schematic view of an exemplary computing environment in which the exemplary embodiments of the present disclosure may be implemented.

It is described above that the present disclosure may be generally implemented by the computing device, but those skilled in the art will well know that the present disclosure may be implemented in association with a computer executable instruction and/or other program modules which may be executed on one or more computers and/or as a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable instruction, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an internal hard disk drive (HDD) 1114 (for example, EIDE and SATA)—the internal hard disk drive (HDD) 1114 may also be configured for an external purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable instructions for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as the Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11 (a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art of the present disclosure that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art of the present disclosure that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various exemplary embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be interpreted within the widest range which is coherent with the principles and new features presented herein.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for training an artificial intelligence model on a computing device, which is executable by an embedded device, wherein the method is performed by the computing device, comprising:
transforming a first artificial intelligence model pretrained on a first execution environment of the computing device into a second artificial intelligence model corresponding to the embedded device having a second execution environment which is different from the first environment of the computing device, wherein the transforming comprises transforming weights or activation values in a model from a format of a first bit precision supported by the first execution environment to a format of a second bit precision supported by the second execution environment, where a value of the first bit precision is greater than a value of the second bit precision;
synchronizing the second artificial intelligence model and a dataset stored on the computing device with a network storage module connected via a network to the computing device and the embedded device, wherein the synchronized dataset and the synchronized second artificial intelligence model are accessible by both the computing device and the embedded device;
requesting the embedded device to perform inference of the synchronized second artificial intelligence model using the synchronized dataset in the second execution environment, and receiving first result data according to the performance of the inference from the embedded device; and
training, by the computing device, the second artificial intelligence model to be executed on the embedded device, using the first result data, and
wherein the requesting the embedded device to perform the inference of the synchronized second artificial intelligence model using the synchronized dataset in the second execution environment comprises:
transmitting an initialization request for a driver to perform inference on the embedded device and an inference request signal including path information of the synchronized dataset on the network storage module, to the embedded device.

2. The method of claim 1, wherein the training the second artificial intelligence model to be executed on the embedded device, using the first result data comprises:
updating, by the computing device, loss of the first artificial intelligence model based on the first result data; and
updating, by the computing device, weights of the second artificial intelligence model based on the updated loss of the first artificial intelligence model.

3. The method of claim 2, wherein the updating the loss of the first artificial intelligence model based on the first result data comprises:
updating the loss of the first artificial intelligence model using difference between the first result data and ground truth data of the dataset, wherein the first result data is transformed by the embedded device to correspond to the computing device having the first execution environment.

4. The method of claim 2, wherein the updating the loss of the first artificial intelligence model based on the first result data comprises:
transforming the first result data to correspond to the computing device having the first execution environment, and updating the loss of the first artificial intelligence model using difference between the transformed first result data and the ground truth data of the dataset.

5. The method of claim 2, wherein the updating the weights of the second artificial intelligence model based on the updated loss of the first artificial intelligence model comprises:
generating a third artificial intelligence model which is quantized to the second bit precision, by transforming the first artificial intelligence model which includes the updated loss, to correspond to the embedded device; and
updating the weights of the second artificial intelligence model with weights of the third artificial intelligence model.

6. The method of claim 2, wherein the updating the loss of the first artificial intelligence model based on the first result data comprises:
generating second result data from input data including the dataset using the first artificial intelligence model;
calculating knowledge distillation loss using difference between the first result data of the second artificial intelligence model and the second result data of the first artificial intelligence model;
calculating the loss of the first artificial intelligence model using difference between the second result data of the first artificial intelligence model and ground truth data of the dataset; and
updating the loss of the first artificial intelligence model by reflecting the calculated knowledge distillation loss and the calculated loss of the first artificial intelligence model into the first artificial intelligence model, and
wherein the updating the weights of the second artificial intelligence model based on the loss of the first artificial intelligence model comprises:
updating the weights of the second artificial intelligence model based on the calculated knowledge distillation loss and the loss of the first artificial intelligence model.

7. The method of claim 1, wherein the inference request signal further includes batch-specific path information synchronized on the network storage module when the inference request signal requests performance of batch inference.

8. The method of claim 1, wherein the first execution environment comprises a computing execution environment operable by at least one of a central processing unit (CPU) or a graphics processing unit (GPU), and the second execution environment comprises a computing execution environment operable by a neural processing unit (NPU).

9. The method of claim 1, wherein the first artificial intelligence model is located in a storage space of the computing device, and the dataset for training the second artificial intelligence model and the second artificial intelligence model are generated or obtained by the computing device.

10. The method of claim 1, wherein after the transforming the first artificial intelligence model into the second artificial intelligence model, the method further comprises:
when it is determined that an abnormality associated with the second artificial intelligence model exists based on tensors of output data generated by inputting the same input data into both the first artificial intelligence model and the second artificial intelligence model, identifying a cause of the abnormality associated with the second artificial intelligence model using a way of changing a shape of a matrix of data.

11. The method of claim 10, wherein the way of changing the shape of the matrix of data involves changing the shape of the matrix of the data without performing a separate transformation process to transform the artificial intelligence model, and
when the cause of the abnormality associated with the second artificial intelligence model is determined not to have originated from the shape of the matrix of the data, the method returns to the transforming the first artificial intelligence model.

12. The method of claim 10, wherein the abnormality associated with the second artificial intelligence model is identified as abnormality when a similarity between tensors of the output data is less than a predetermined threshold.

13. The method of claim 1, wherein after the transforming the first artificial intelligence model into the second artificial intelligence model, the method further comprises:
synchronizing a dummy dataset for testing stored on the computing device with the network storage module;
generating third result data by performing inference of the first artificial intelligence model using the dummy dataset in the first execution environment and synchronizing the generated third result data with the network storage module; and
receiving a validation result of the second artificial intelligence model generated at least partially based on the synchronized dummy dataset and the synchronized third result data from the embedded device.

14. The method of claim 13, wherein the validation result of the second artificial intelligence model is generated by the embedded device by determining a first similarity between fourth result data generated by performing inference of the second artificial intelligence model using the synchronized dummy dataset in the second execution environment and the synchronized third result data.

15. The method of claim 14, wherein: the validation result of the second artificial intelligence model is generated, by applying a flatten into the third result data and the fourth result data to transform the third result data and the fourth result data into one dimension, sorting the flattened third result data and the flattened fourth result data using a predetermined criterion, and determining the first similarity between the sorted third result data and the sorted fourth result data.

16. The method of claim 14, wherein when the first similarity is less than a predetermined threshold, it is determined that an abnormality associated with the second artificial intelligence model exists, and
wherein the method further comprises identifying a cause of the abnormality associated with the second artificial intelligence model using a way of changing a shape of a matrix of data when it is determined that the abnormality exists.

17. The method of claim 16, wherein the identifying the cause of the abnormality comprises:
after changing the shape of the matrix of data,
generating fifth result data by performing inference of the first artificial intelligence model using the dummy dataset in the first execution environment and synchronizing the generated fifth result data with the network storage module;
receiving second similarity between sixth result data generated by performing inference of the second artificial intelligence model with the changed shape of the matrix of data using the synchronized dummy dataset in the second execution environment and the synchronized fifth result data, from the embedded device; and
identifying the cause of the abnormality based on the second similarity, and
wherein the identifying the cause of the abnormality based on the second similarity comprises determining that the abnormality associated with the second artificial intelligence model is caused by the shape of the matrix of the data when the second similarity is greater than or equal to a predetermined threshold.

18. The method of claim 1, wherein the transforming the first artificial intelligence model comprises:
quantizing the first artificial intelligence model operable in the first execution environment of the computing device into the second artificial intelligence model operable in the second execution environment of the embedded device using an application programming interface for quantizing to a model operable on the embedded device, wherein the second artificial intelligence model is incapable of being executed or simulated on the computing device, and is capable of being executed or simulated on the embedded device, and
wherein a quantization algorithm or quantization parameter in the application programming interface is a structure which is not able to be recognized by the computing device.

19. A computer program stored in non-transitory computer readable medium, wherein the computer program cause one or more processors of a computer device to performs a method for training an artificial intelligence model on the computing device, which is executable by an embedded device and wherein the method comprises:
transforming a first artificial intelligence model pretrained on a first execution environment of the computing device into a second artificial intelligence model corresponding to the embedded device having a second execution environment which is different from the first environment of the computing device, wherein the transforming comprises transforming weights or activation values in a model from a format of a first bit precision supported by the first execution environment to a format of a second bit precision supported by the second execution environment, where a value of the first bit precision is greater than a value of the second bit precision;
synchronizing the second artificial intelligence model and a dataset stored on the computing device with a network storage module connected via a network to the computing device and the embedded device, wherein the synchronized dataset and the synchronized second artificial intelligence model are accessible by both the computing device and the embedded device;
requesting the embedded device to perform inference of the synchronized second artificial intelligence model using the synchronized dataset in the second execution environment, and receiving first result data according to the performance of the inference from the embedded device; and
training, by the computing device, the second artificial intelligence model to be executed on the embedded device, using the first result data, and
wherein the requesting the embedded device to perform the inference of the synchronized second artificial intelligence model using the synchronized dataset in the second execution environment comprises:
transmitting an initialization request for a driver to perform inference on the embedded device and an inference request signal including path information of the synchronized dataset on the network storage module, to the embedded device.

20. A computing device for training an artificial intelligence model on the computing device, which is executable by an embedded device and wherein the computing device comprises a processor, a memory and a network unit and the processor performs:
transforming a first artificial intelligence model pretrained on a first execution environment of the computing device into a second artificial intelligence model corresponding to the embedded device having a second execution environment which is different from the first environment of the computing device, wherein the transforming comprises transforming weights or activation values in a model from a format of a first bit precision supported by the first execution environment to a format of a second bit precision supported by the second execution environment, where a value of the first bit precision is greater than a value of the second bit precision;
synchronizing the second artificial intelligence model and a dataset stored on the computing device with a network storage module connected via a network to the computing device and the embedded device, wherein the synchronized dataset and the synchronized second artificial intelligence model are accessible by both the computing device and the embedded device;
requesting the embedded device to perform inference of the synchronized second artificial intelligence model using the synchronized dataset in the second execution environment, and receiving first result data according to the performance of the inference from the embedded device; and
training, by the computing device, the second artificial intelligence model to be executed on the embedded device, using the first result data, and
wherein the requesting the embedded device to perform the inference of the synchronized second artificial intelligence model using the synchronized dataset in the second execution environment comprises:
transmitting an initialization request for a driver to perform inference on the embedded device and an inference request signal including path information of the synchronized dataset on the network storage module, to the embedded device.
